(19) United States
(12) Patent Application Publication
(10) Pub. No.: US 2011/0097464 A1
(43) Pub. Date: Apr. 28, 2011

(54) METHOD FOR LIQUID PROCESSING

(75) Inventors: MARIA HOLM, ALMHULT (SE); OLA LIND, UPPSALA (SE); JAMES VAN ALSTINE, STOCKHOLM (SE)

(73) Assignee: GE HEALTHCARE BIO-SCIENCES AB, UPPSALA (SE)

(21) Appl. No.: 12/909,120

(22) Filed: Oct. 21, 2010

(30) Foreign Application Priority Data
Oct. 22, 2009 (SE) 0950777-3

(51) Int. Cl. C12H 1/04; C12G 1/00; A23L 2/80

(52) U.S. Cl. 426/422

(57) ABSTRACT

The present invention relates to liquid clarification and stabilization. More closely, the invention relates to both clarification by removal of suspended particles, as well as stabilization against formation of non-microbial haze via reduction of haze forming substances in various liquids. The haze forming substances are proteins and polyphenol tannins which occur in various plant related fluids such as beer wine, juices, flavorings, plant extracts, and even bioprocess streams. The method of the invention accomplishes both size based removal of colloidal non-haze related particles as well as adsorption based removal of haze forming substances without a need for added flocculants. The to method of the invention utilizes hydrophilic surfaces for adsorption of haze forming substances with such surfaces presented by materials arranged in manner so that size based exclusion of suspended particles is also achieved.

### CROSS-REFERENCE TO RELATED APPLICATIONS

This application claims priority to Swedish patent application number 0950777-3 filed Oct. 22, 2009; the disclosure of which is incorporated herein by reference in its entirety.

### FIELD OF THE INVENTION

The present invention relates to liquid clarification and stabilization. More closely, to the invention relates to clarification by removal of suspended particles, and stabilization against non-microbial haze formation via reduction of haze forming substances. The haze forming substances are proteins and polyphenol tannins which occur in various plant related fluids including beer, wine, vinegar, juices, flavorings, plant extracts, and even biotechnical process streams. The two tasks of removing suspended particles and reducing haze forming substances are often accomplished using two or more separate unit operations which often different apparatus and separation methods, including possible addition of flocculation agents which must later be removed. The method of the invention allows for a single device which can accomplish both size based removal of colloidal non-haze related particles as well as adsorption based removal of haze forming substances without a need for added flocculants.

### BACKGROUND OF THE INVENTION

In the example of commercial beer production two common tasks which must be carried out on the initial beverage under processing are A. clarification related to reducing cell debris, protein aggregate or other particles, and B. stabilization related to reduction of substances which form suspended haze often called chill haze. These two tasks are typically performed using one or more separate unit operations for each task and with each operation related to separate devices which contain separate active units (filters, particles in packed beds, etc.). Clarification is directed at elimination of approximately submicron or larger size particles related to fermentation or other process fluids. Such particles are present after the extraction or fermentation and initial centrifugation, decantation or crude filtration of the ferment to remove substantial biomass. Various approaches can be used though filtration methods are becoming more popular. By comparison colloidal chill haze relates to particles which result from formation of to macromolecular complexes by of fluid constituents such as proteins and polyphenol tannins Nonbacterial haze formation is an active and complex process. Haze typically increases over time and at reduced temperatures and is also influenced by many factors such as alcohol levels. The resulting haze which is sometimes called chill haze is typically not a health concern but is unseemly and can affect use of the fluids. Thus in the case of beer it can negatively affect enjoyment of the drinking experience. As such it can limit the commercial shelf storage life of beverages; which is to say the time the producer and seller have to recoup profit on their investment.

As with many fluids based on plants, beer contains both polyphenols and proteins which originate with the plant grains used in its production. Such proteins include those rich in proline amino acid residues which tend to more favorably interact with polyphenol tannins Polyphenols and proteins are common to a variety of liquids which may be prone to formation of nonmicrobial haze, as well as a need for removal of other particulates. Clarification and haze stabilization processing challenges are common to processing of fruit juices, concentrates, flavorings and a variety of other food related beverages and liquids. A related example involves processing of liquids related to purification of recombinant proteins produced in plants, and where protein-polyphenol complexes may compromise the lifetime or effectiveness of filters and chromatography beds. So too it should be appreciated that polyphenols found in various foods and beverages (including sorghum, millet, cocoa, coffee, tea, wine) are able to complex salivary and other body proteins and glycoproteins to impart astringency and other undesired tastes as well as some harmful effects.

The literature on treatment of beer to reduce haze formation offers little consensus on exact mechanisms responsible for haze formation. In truth, the relative importance of different mechanisms may vary from beer to beer, brewery to brewery, and with different to conditions such as storage temperature. However it does appear that haze is formed via micro and then macroscopic assembly formation based on interaction of proteins and polyphenols. Some (e.g., proline-rich) proteins and some (e.g. dimeric flavan-3-ol) polyphenols may be more prone to haze formation than other proteins and phenols. Significant haze formation appears to be somewhat of a time- and temperature-dependent and thus stochastic process. As such its reduction to consumer desired levels can be obtained by various routes including reducing concentrations of the proteins or polyphenols, or both the proteins and polyphenols involved in haze formation. Naturally what is more to be desired is reduction of specific protein or polyphenol substances which are most prone to produce haze formation. That outcome is desired as it results in less reduction in natural beverage constituents.

For simplification one can consider three approaches to effecting clarification and stabilization. These are the classic historical approach which has evolved since antiquity, a more modern approach often in use today, and the novel approach of the current invention. In the classic approach material will be clarified (possibly as noted above following some preliminary treatment to reduce biomass). Older decantation methods have given rise to more modern filtration approaches with hollow fibre membranes now being supplanted by the more efficient cross flow filtration method. This step will be followed by stabilization based on adding a flocculant to the fluid. Common flocculants have evolved from animal extracts used in the middle ages to polymers such as polyvinylpyrrolidone (e.g. PolyClar AT) which tends to complex polyphenols, or silica derivatives which tend to complex proteins. The flocculent complexes they form with the fluids components are then removed by a second step which typically involves filtration. The classic approach has several weaknesses. First the need for second filtration step. Second the possibility that not all the flocculating agent is removed. Third cost and ecological challenges related to disposal of the filtered flocculent retentates.

Some flocculants are designated to interact with complex forming proteins including WO 2005/113738 “Method of Preparing a Liquid Containing Proteins for Subsequent Separation By Using One or More Protein Complexing Agents”. U.S. Pat. No. 7,160,563 relates to a method of preparing beer from beer wort which includes adding aminated pectin to inhibit coagulation and precipitation by binding to haze forming substances. Other modified pectins are noted in WO 2006/032088. Other amine containing flocculants have been suggested by other inventors such as WO 1998/000453 which describes Polyamide Compositions for Removal of Polyphenols from Liquids. U.S. Pat. No. 6,565,905 relates to use of Silica Gel for Stabilization Treatment of Beer. GB 887796 refers to use of thermoresponsive polymer or copolymer which binds haze forming substances and is then precipitated by cooling the solution below the cloud point of the polymer or copolymer. In some cases the regimes for adding one or more different flocculating agents may be somewhat complex. Thus U.S. Pat. No. 3,958,023 covers improving the chill haze stability of aqueous liquids derived from fruits and vegetables (e.g. beer, wine, juices, vinegar, etc.) by using one or more haze control agents in a layer in the filter media. Such agents are then also added after storage and removed in final filtration step prior to shipping so as to reduce the storage time and space required by post filtration chill haze control techniques.

Of course some filtration techniques can be adapted to reduce not only chill haze forming substances but also micron sized haze complexes (EP 0 427 099). However it should be noted that, as in the case of flocculent aided techniques the haze forming substances are being removed via a form of size exclusion based on the their physical dimensions, not adsorption based on their chemical properties and functional groups.

The more modern approach which has evolved to address some of these challenges involves replacing flocculants with solid phase insoluble porous materials which can complex or otherwise scavenge polyphenol or protein substances, as beer or other fluids containing such substances pass through a bed of the porous material. Common surface localized substances include polyvinylpyrrolidone (PVPP) as well as other materials known to bind and flocculate polyphenols or proteins. In some cases filters or membranes one advantage of this approach is that the scavenging device can be cleaned and reused. One weakness is that such cleaning may not be 100% efficient or may lead to PVPP or other substances leeching into the fluid process stream. Two other weaknesses stand out. First that this approach requires significant capital investment in dedicated equipment which may not be as readily adapted as filters and flocculent reagents to varying process fluid volumes. Secondly that while an entire fluid sample is generally subjected to clarification, it may only be necessary to subject part of the sample to stabilization in order to reduce polyphenol or protein concentrations to the desired level. The related partial diversion of process flow may be especially desired if stabilizing the entire fluid sample alters it unfavorably such as in the case of a beverage reducing enjoyment of the drinking experience. Possible need for clarification of total sample process fluid volumes but only stabilization of partial volumes reinforces the need for separate and therefore less cost effective unit operations for clarification and stabilization.

Early attempts to develop solid phase based scavengers of haze forming substances focused on flocculating agents immobilized on particles in packed or fluidized beds. Thus U.S. Pat. No. 4,166,141 relates to chill stabilizing a malt beverage by passing it through a bed of adsorbant particles such as PVP or silica gel so as to adsorb proteinaceous or tannin materials. Such an approach still requires filtration or other clarification steps to remove biomass and colloidal particles upstream of the stabilization (haze forming substance removal) operation.

More recently ion exchange media has been used for stabilization, including anion exchange media based on cross-linked agarose. U.S. Pat. No. 6,001,406 describes a method for the simultaneous removal of polyphenols and proteins from a beverage by contacting the beverage with an ion exchanger that is capable of adsorbing both types of substances. The characteristic feature of the ion exchanger to be used is that it is a water insoluble porous hydrophilic matrix to which ion exchanging groups are covalently bound. The goal of this unit operation is only to remove enough haze forming substances to eliminate significant haze formation; not to remove all the haze promoting substances as they may also confer head-foam formation, flavor tones and other favorable properties on the beer. Thus the entire beverage process stream may not be treated. This system is typically used in a defined column apparatus referred to as a combined stabilization system (CSS). The term combined relates to expectation that both proteins and polyphenols will be adsorbed onto the matrix.

Irrespective of the adsorbing (scavenging) format or device used the need for specific ligands or other surface treatments may not offer high specificity in regard to targeting the haze forming substances they remove from the process stream. This has two potential outcomes. First the need, as noted above, to only treat part of the process stream and therefore to have stabilization as separate unit operation from clarification. Secondly the potential for scavenging materials such as columns to be readily fouled after processing suboptimal volumes of solution.

WO 2008/097154 recently suggested that solid phase surfaces which offer hydrogen bond or other groups may interact preferentially with certain polyphenol compounds which promote haze formation to a greater extent than other polyphenols. Such materials or coatings are relatively easy to produce, chemically stable, do not readily suffer from non-specific fouling and may offer some economical advantages in regard to production and use of devices whose surfaces preferentially scavenge polyphenol tannins which are active haze forming substances. There are of course several ways to modify surfaces to achieve hydrogen bond forming capability. These include grafting of various polymers containing polyether or polyhydroxy groups. Other methods include in situ polymerization of functional groups. One method is radical initiated grafting of vinyl ether reagents, which method has been shown to be capable of generating modified surfaces on porous chromatography particles without blocking pores.

In addition to the above methods many others have been suggested in regard to stabilization of beverages. One example is EP 1 464 234 Method for the Prevention or Reduction of Haze in Beverages which relates to addition of prolyl-specific endoproteases. Supposedly these enzymes might be left in the beverage or removed via complication separation processes.

### SUMMARY OF THE INVENTION

The present invention provides an approach whereby various filter or other solid phase liquid sample purification devices can be used to effect both particle size filtration (clarification) and chill haze stabilization (scavenging of haze forming substances). This is based on realization that while stabilization is related to size exclusion effects (i.e. flow pore dimensions) scavenging of haze forming substances is performed at surfaces via adsorption. This invention allows for a single unit operation and related products to more cost effectively process various fluids requiring removal or reduction of suspended particles as well as polyphenols or haze forming proteins. Or for a unit operation which can effect primary scavenging functions while also effecting secondary clarification.

In some cases the size exclusion device material such as regenerated cellulose acetate filters or polysaccharide based chromatography particles may offer enough to necessary hydrogen bonding or other groups to effect the required stabilization. In other cases such materials may be modified by various surface treatments such as grafting of quaternary ammonium (Q) cationic ligands or modification with polyether groups via, for example, radical initiated in situ surface grafting of vinyl ether groups (RIGVE) to form a polymer modified surface. Another way to generate such polymer modified surfaces is via grafting of preformed polymers to the filter or other solid phase surface. All of the above methods are shown to be able to generate suitable scavenging stabilization surfaces which also offer effective clarification. Therefore the invention includes different ligand approaches which may be useful to different degrees in varied applications and in regard to construction of a variety of devices and products. Such products might include chemically stable filters or other media such as chromatography particles or monolithic packed beds which can be used for both clarification and stabilization at the same time and then cleaned or sterilized via exposure to various combinations of back pressure and chemical agents. Or they might include single use disposable products where lack of advanced or complicated surface treatments allows for cost effectiveness, while choice of materials (e.g. cellulose or agarose based) allows for ecological friendliness.

It should be noted that while chromatographic beds of particles such as Q SEPHAROSE™ Big Beads offer both clarification and stabilization chromatographic particles are typically not used for such purposes. There are two reasons for this. First such particles tend to be rather expensive and it is best if they can be used to treat as much fluid as possible. Their value for clarification may not compare favorably with filtration devices while their value for stabilization does. Limiting their lifetime to one or two runs where they are fouled by particles may not be economically viable. Secondly while entire fluid streams may be treated for clarification only partially fluid streams may be treated to achieve stabilization. The invention provides two solutions to the above to challenges. The first is filters which offer both clarification and stabilization. The second is filters or beads which offer coatings which show tendency to preferentially bind polyphenol substances with a greater tendency to promote haze formation.

In some cases it may be desired for the entire beverage or fluid process stream to be subjected to both clarification and stabilization. The invention allows for two approaches to this. The first is via materials and, if desired, surface treatments which scavenge a lower amount of haze forming precursor but still allow for stabilization when the entire process volume is so treated. The second approach is via materials and surface treatments which allow for more specific removal of haze forming precursors with greater tendency to induce haze formation.

Since such materials according to the invention may scavenge less components of a beverage or bioprocess stream or other fluid sample they can be used to treat greater volumes. For some applications other desirable attributes might be low fouling, easily cleaned surfaces such as those which do not have charged coatings. Use of materials or coatings which offer selectivity and low fouling coupled to chemical stability and biocompatibility may be particularly attractive. In this regard use of hydroxyl, polyether or other group containing substances which appear from work related to the present invention to be able to selectively bind polyphenols, but generally offer reduced non-specific adsorption of proteins and hence fouling, are particularly attractive approaches to production of cost effective products offering both clarification and stabilization.

Thus, the invention relates to a method for liquid processing comprising contacting the liquid with a separation device or matrix which allows for both particle removal from said liquid by size exclusion, and stabilization against haze formation by adsorptive removal of haze forming substances from said liquid, to be accomplished in the same operation.

Preferably, the separation matrix comprises a polymeric support which is porous so as to allow for optimal adsorptive contact area. The polymeric support may be a cross-linked carbohydrate support. Alternatively, the polymeric support comprises polycarbonyl, polyhydroxy, polyether or polyacid either throughout or as coatings applied to polymeric, glass or other structures. Different types of dual function separation matrices may be employed in tandem, or serially or in parallel.

The surfaces of the polymeric support may exhibit hydroxyl groups or ethoxy groups or charged groups such as anion exchange groups including quaternary amines.

In another embodiment, the polymeric support is surface-modified with hydrogen bond donator or acceptor groups. The hydrogen bonding groups may comprise lone-pair electrons and are based on polymers or other ligands containing, for example, hydroxyl groups, ether groups, carboxyl groups, carbonyl groups, amine groups. The hydrogen bonding groups may be ethylene glycol or other ethoxy based ligands. The hydrogen bonding groups may also comprise Tris or similar functionalities (e.g. proline or inositol groups). The hydrogen bonding groups comprise part of a responsive polymer or silicone based polymer.

The ether-ligands may be in mixture with other ligands or media.

The separation matrix comprises for example a filter, cross flow filter, packed chromatography bed, expanded chromatography bed, radial flow chromatography bed, and involves various solid phase separation media (particles, porous beads, monoliths, fabric, membranes etc.).

The separation matrix may have hydrogen bonding and filtration capacity which are achieved using the same material, e.g. regenerated cellulose, or cross-linked agarose or other polysaccharide.

The adsorptive surface preferably has specificity for a subclass of haze forming to substances such as certain types of proteins or certain types of polyphenol tannins. In the case of tannins these would be dimeric or higher polyphenols. The adsorptive surface may be improved via modification with various surface treatment including exposure to oxidative, reducing or other reagents, covalent grafting of quaternary ammonium or other cationic ligands, covalent grafting or irreversible adsorption of various polymers which provide hydrogen bonding or other groups, modification of surface by various treatments involving chemical reactions at the surface including radical initiated grafting of vinyl ether reagents or plasma radio frequency based treatments.

The liquid to be processed with the method of the invention is preferably a beverage selected from beer, wine, juice or flavorings or a plant extract including fluid related to bioprocessing of recombinant plant products.

The method according to the invention may be optimized by altering temperature or addition of various additives such as surfactants in regard to improving efficiencies via control over viscosity and back pressure, particle size filtration, haze former adsorption, etc.

One way to enhance stabilization according to the invention is to increase the relative ratio of monomeric polyphenols to the dimeric or higher polyphenols which exhibit greater capability to induce haze complex formation. Surfaces capable of effecting such an increase, by preferentially binding dimeric or higher polyphenols, not only appear to provide for effective stabilization but they are also expected to be lower fouling and offer the least change in natural composition of the beverage or other fluid in question. Given that some secondary interactions may occur between bound dimeric polyphenols and monomeric polyphenols it is probably not possible to design a filter or other device which does not remove some monomeric polyphenols. However it has been shown here that significant alteration in their ratios can be effected. Another way to stabilize beverages or other haze forming fluids may be to add monomeric polyphenols, or perhaps analogues such as phenol group containing vitamin or amino acid based substances.

### BRIEF DESCRIPTION OF THE DRAWINGS

FIG. 1 shows a simplified diagram of (post centrifugation) treatment of beverage, ferment or related liquid showing three paths for clarification (particle removal) and stabilization (removal of haze and haze formers) Classic three step (1a, 2a, 3a), Modern two step (1b, 2b) and the Novel one step method of the invention (1c).

FIG. 2 shows the reduction in microparticle concentration following passage of beer sample 1 through chromatographic or filtration media which are also capable of scavenging haze complex forming substances. Two particle ranges are shown. Membrane dimensions are prior to surface treatment.

FIG. 3 shows the chill haze analysis for beer sample 1 on day 1. Effects of various beer volumes (100 to 800 ml) passing through different stabilization beds including quaternary amine modified SEPHAROSE™ Big Beads (Q SEPHAROSE™ BB) and Q modified 5 micron cellulose acetate (CA) membrane.

FIG. 4 shows the chill haze analysis for beer sample 1 on day 2. Effects of various beer volumes (100 to 800 ml) passing through different stabilization beds including unmodified 1.2 micron cellulose acetate (CA) membrane, and quaternary amine modified SEPHAROSE™ Big Beads (Q SEPHAROSE™ BB).

to FIG. 5 shows the relative chill haze analysis for beer sample 2 day 3. Effects of various beer volumes (100 to 800 ml) passing through different stabilization beds including Q SEPHAROSE™ Big Beads (Q SEPHAROSE™ BB), diethylene glycol vinyl ether (DEGVE) coated SEPHAROSE™ 6 Fast Flow beads (SEPHAROSE™ 6 FF) prototype U2277038, and a 1 to 4 (v/v) mixture of DEGVE treated and untreated SEPHAROSE™ 6 EP beads.

FIG. 6 shows the chill haze analysis for beer sample 2 on day 4. Effects of various beer volumes (100 to 800 ml) passing through different stabilization beds including Q SEPHAROSE™ Big Beads (Q SEPHAROSE™ BB), and diethylene glycol vinyl ether (DEGVE) coated 5 micron cellulose acetate (CA) membrane.

FIG. 7 shows the reproducibility and comparison of various particle and membrane formats to reduce beer haze at different times in different beer samples shown by expressing EBC haze level as a percentage of untreated controls.

FIG. 8 shows the differential elution retardation of monomeric (+) catchein versus dimeric procyanidine B2 standards from bed of Q membrane prototype U20760049.

FIG. 9 shows the polyphenol flavanol standards (+) catechin (monomeric) and procyanidine B2 (dimeric) injected and retarded at 2 mL/min on 1 mL Q SEPHAROSE™ Big Bead column Excess polyphenol that has not adsorbed elutes at 56 and 284 mL.

FIG. 10 shows the beer stabilization capability of various porous substrates versus their capacity for polyphenol standards (+) catechin and procyanidin B2.

FIG. 11 shows the relative capacity ratio of prototypes to scavenge (+) catechin to procyanidin B2 plus relative stabilization performance relative to Q Big Beads (line) shown for various media tested.

### DETAILED DESCRIPTION OF THE INVENTION

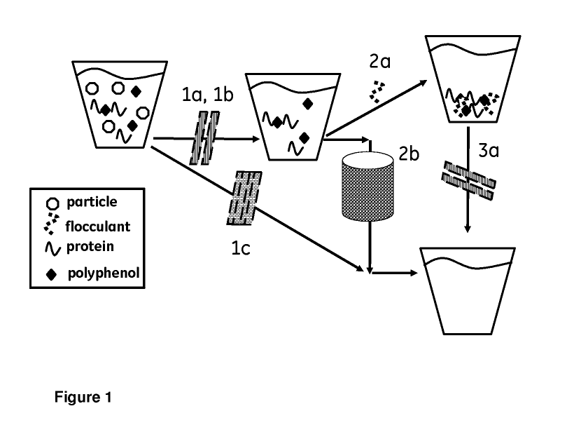

As shown schematically in FIG. 1 there are two basic prior art approaches (FIG. 1, paths a and b) to chill haze reduction in beer production. Both involve removal of one or more chill haze forming substances below the critical levels required for significant complex (chill haze) formation. They can be preceded by a centrifugation decantation or other step to remove bulk biomass. Similar processing is common in regard to processing of beers, juices, and other plant extracts as well as in processing of recombinant plant extracts. Following initial biomass removal the process stream is subjected to filtration (or analogous size exclusion step) to effect clarification in terms of removal of readily visible suspended colloid particles. These can contain cell debris, protein aggregates, or other substances native to the fluid in question. In the classic approach (FIG. 1 path a) the initial filtration step (1a) is followed by addition of one or more flocculation (i.e. fining) agents (FIG. 1, step 2a) which complex with various haze forming substances. Haze forming compounds are often removed by bulk addition of “fining agents” such as hydrophilic silica hydrogel (silica) which binds interacting polypeptides or polyvinylpolypyrrolidone (PVPP) or similar products (such as the commercial agent Polyclar®) which bind polyphenols. These agents are mixed with the beer and then removed from it by decanting/filtration or similar processes (FIG. 1, step 3a). Similar haze reducing methods and procedures have been known and used for hundreds of years.

As noted above various inventive polymers have been developed for use as flocculants to stabilize beer and other beverages or fluids from plants. The classic approach has several weaknesses such as the need for second filtration step, the possibility that not all of the added flocculent is removed from the process stream, and the various ecological concerns related to recovery, treatment, and disposal of single use flocculants and their complexes.

In the more modern approach the initially clarified fluid stream (FIG. 1, step 1b) is exposed to a solid phase (insoluble) surface which removes haze forming precursors via adsorption (FIG. 1, step 2b). Various types of solid phase type apparatus may be used such as scavenging filters or chromatography particles. Early attempts to develop solid phase based scavengers of haze forming substances focused on flocculating agents immobilized on particles in packed or fluidized beds. U.S. Pat. No. 4,166,141 relates to chill stabilizing a malt beverage by passing it through a bed of adsorbant particles such as PVP or silica gel so as to adsorb protein or tannin materials.

More recently ion exchange media has been used for stabilization, including anion exchange media based on cross-linked agarose (U.S. Pat. No. 6,001,406). Such media offers several functional groups which may bind various targets. Such groups include charge groups for ion exchange and hydrogen bonding groups. The apparent advantage of the media is that it may remove both polyphenols and proteins which are haze forming substances.

Irrespective if the adsorbing (scavenging) surface related to a filter, chromatography particle, monolith or other format is a filter, chromatography bead or other format, they can be costly to produce given the need for specific ligands, polymers or other affinity substances to be added to the underlying surface in manner to be chemically stable and not leech into process streams. In addition PVPP, silica, charged ligand or other scavenging substrates may not offer high specificity in regard to targeting the haze forming substances they remove from the process stream. This has two potential outcomes. First the need, as noted above, to only treat part of the process stream and therefore to have stabilization as separate unit operation from clarification. Secondly the potential for scavenging materials such as columns to be readily fouled after processing suboptimal volumes of solution.

The present invention and related chemistries appear to solve most if not all of the above challenges while allowing for a single unit operation (FIG. 1, step 1c) to effect the same results as the three steps of the classic approach (FIG. 1, step 1a to 3a) or the two steps of the modern approach (FIG. 1, steps 2a and 2b). However to better appreciate its advantages four points noted above should be emphasized.

A. Various beverages or fluids such as plant extracts exhibit different levels of haze forming substances plus other properties (viscosity, alcohol levels) which suggest that they may require different methods and degrees for stabilization treatment. Process volumes may also vary from time to time and application to application. So it is good to have treatments or related types of apparatus which allow some process flexibility.
B. Haze forming substances such as polyphenol containing compounds and proteins which are reduced in classic, and more modern solid phase adsorption based stabilization approaches may contribute positively to the viscosity and flavor of the beverage and thus the drinking experience. As such their overt non-specific removal is unwanted. The best treatment would only remove enough haze forming substances to achieve the desired level of stabilization.
C. Given a choice of removing protein versus polyphenol tannin haze forming substances the latter may be preferred due to their bitter flavor and negative health effects.
D. Although particle beds can be used for clarification they are, in commercial practice, to hardly ever used for such purposes as they are often more expensive and more difficult to replace than filters. Such differences tend to increase in significance with the size of the fluid volumes being processed.

FIG. 1, step 1c indicates the present invention in regard to a single unit operation carried out with a porous bed, preferably a filter, wherein the filter has two equally important functions. To effect clarification via size based removal of various suspended particles (cells, cell debris, microbiologicals, and protein complexes) as well as stabilization via adsorptive removal of haze forming precursors. Particular emphasis should be placed on polyphenol haze forming substances. As noted above such an invention could find use in the processing of wide variety of beverages and other fluids, and well as bioprocess streams related to plants. Given the wide range of possible applications the approach should involve a range of possible formats and materials some or all of which can be readily scaled.

The experimental strategy for demonstrating development of a filter or chromatographic device capable of both clarification and stabilization was to demonstrate effective particle removal followed by clarification of a real unfiltered, unprocessed commercial beverage stream related to beer production, followed by control studies to demonstrate effective removal of not only haze forming polyphenols but preferential removal of polyphenols with greater ability to promote haze formation.

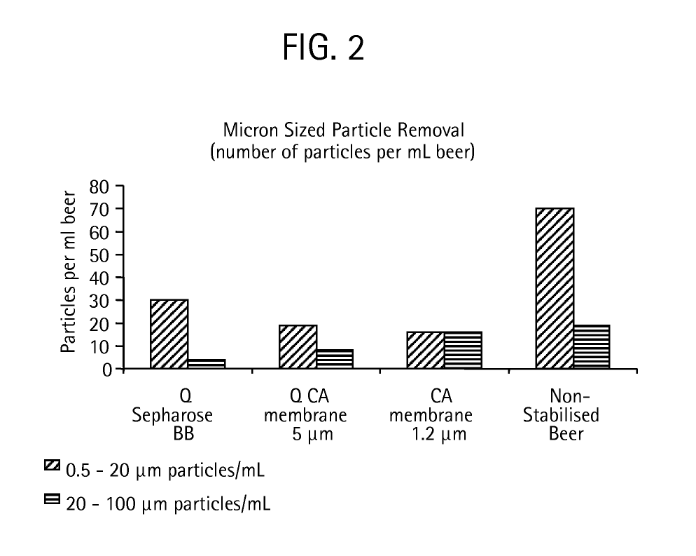

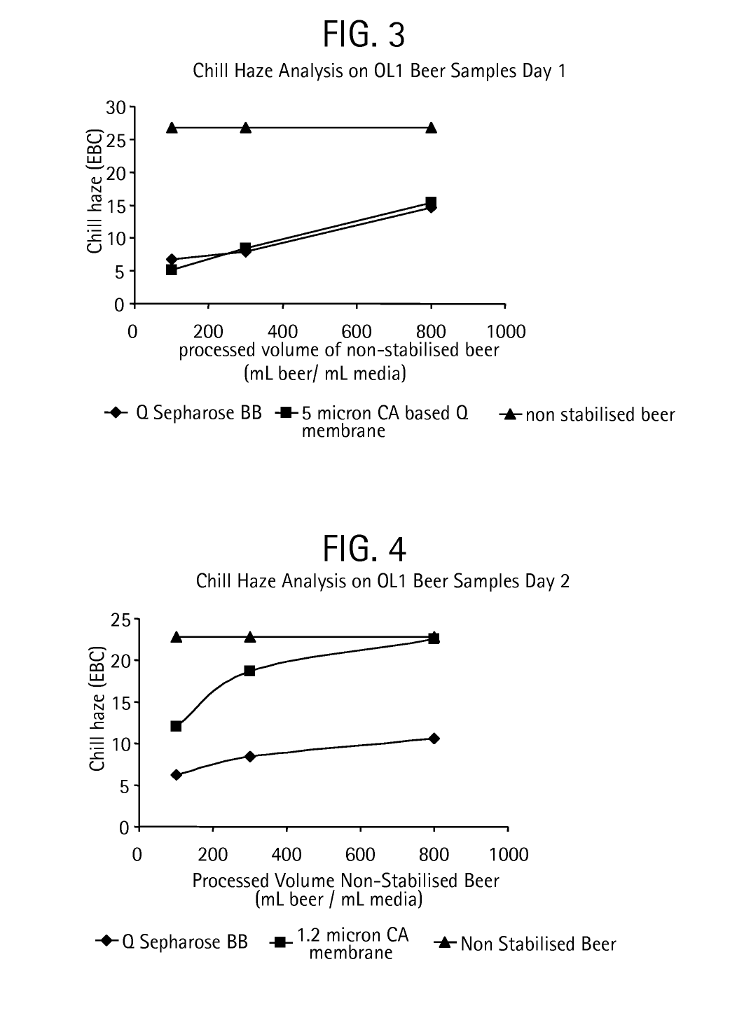

Particle Removal demonstrated using a Sysmex combined particle imaging analyzer (Sysmex Corp., Japan) for particle analysis to measure the number and distribution of micron sized particles in the process stream before and after passage of various amounts of unfiltered beer up to 800 mL through a 1 mL filter or 1-3 mL volume bed (see below). As such they show the ability of the various prototypes to clarify over 200× their volume in beer without any cleaning or other added steps. Typical results are summarized in FIG. 2. As all the test filters and particles used in the study offered reasonable particle clearance they were all used in follow on studies related to both Chill Haze Reduction and Scavenging of Polyphenol Standards related to polypenols with different haze forming capabilities. Chill Haze Analysis was related to EBC haze units measured by Tannometer (Pfeuffer GMBH, Kitzingen, Germany) as in a brewery or fruit juice plant. By lowering the temperature and adding alcohol into the beer, the solubility of the reversible protein-polyphenol complexes was decreased and precipitation appeared. Since the Chill haze induces permanent haze the value from the Chill haze analysis was an important factor for predicting colloidal stability (FIGS. 3 to 6).

FIGS. 3 and 4 shows EBC unit chill haze analysis for beer sample 1 processed on day 1 or 2 showing the relative ability of various prototypes to reduce chill haze when beer samples of different volumes are passed through the filters beds (16 filter pieces of 32 mm i.d.) or 1-3 ml particle beds (see examples). It can be seen, for example, that Q modified 5 micron pore size cellulose acetate (CA) membrane which exhibits good clarification (FIG. 2) also exhibits excellent stabilization (FIG. 3). Significant particle clearance and beer stability is offered even by 1.2 micron CA membrane (FIG. 4). One reason for this may be presence of various groups capable of forming hydrogen bonds with haze forming polyphenols.

FIG. 5 shows how polysaccharide or other solid phase separation media surface can be grafted with polyether coating to effect useful stabilization surface. In this case the surface is SEPHAROSE™ 6 Fast Flow particles modified with polyether polymer formed in situ by radical initiated reaction of diethylene glycol vinyl ether (DEGVE). The DEGVE coated particles appear as effective as Q modified SEPHAROSE™ particles in spite of the fact they are not expected to exhibit charged groups and may be expected to exhibit less non-specific fouling. The particles appear so effective that they can be mixed with unmodified Fast Flow particles and still effect good stabilization.

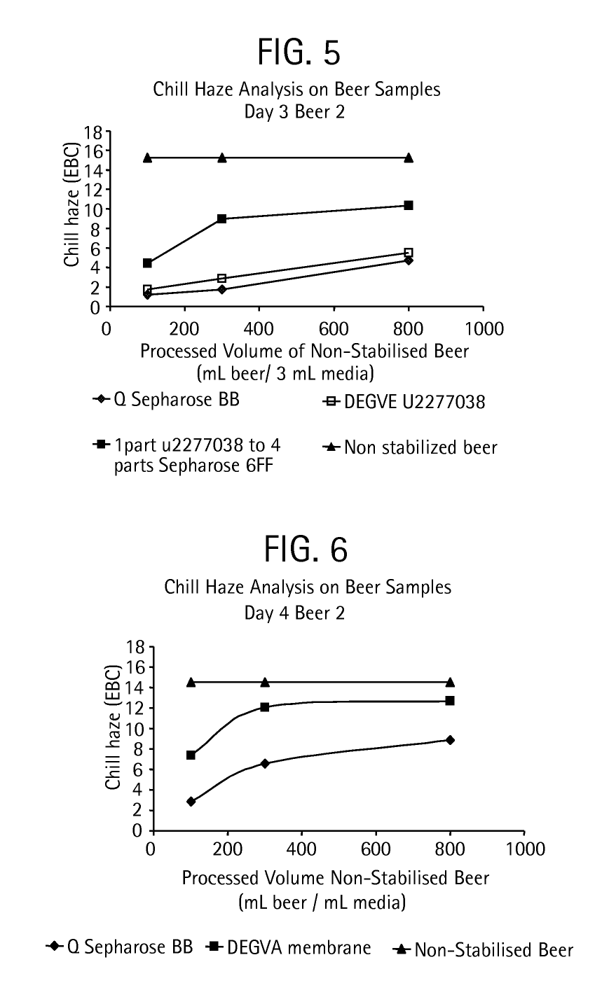

FIG. 6 shows how diethylene glycol vinyl ether (DEGVE) coated 5 micron cellulose acetate (CA) membrane can also offer reasonable stabilization. In this particular case the polymer was preformed and then grafted to the membrane, as opposed to being grafted in situ. It is assumed that the method for producing such prototypes would require some evolution to reach ideal balance of fluid flow versus stabilization in terms of fluid exposed surface area. However the results in FIG. 6 are promising. Especially as this is expected to be a relatively low fouling and nontoxic filter surface treatment.

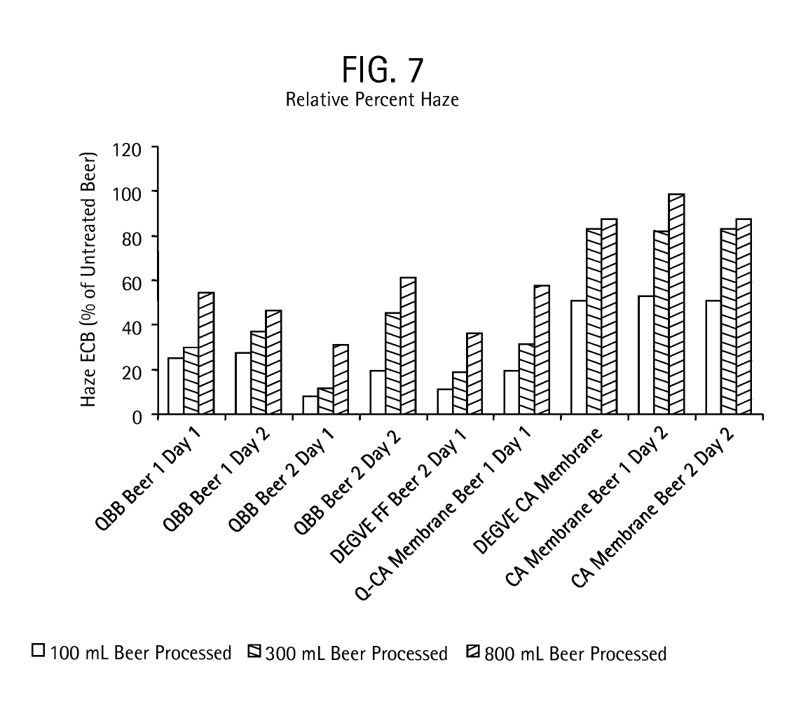

FIG. 7 summarizes the reproducibility and ability of the various particle and membrane formats to reduce beer haze at different times in different beer samples over four months shown by expressing EBC haze level as a percentage of untreated controls.

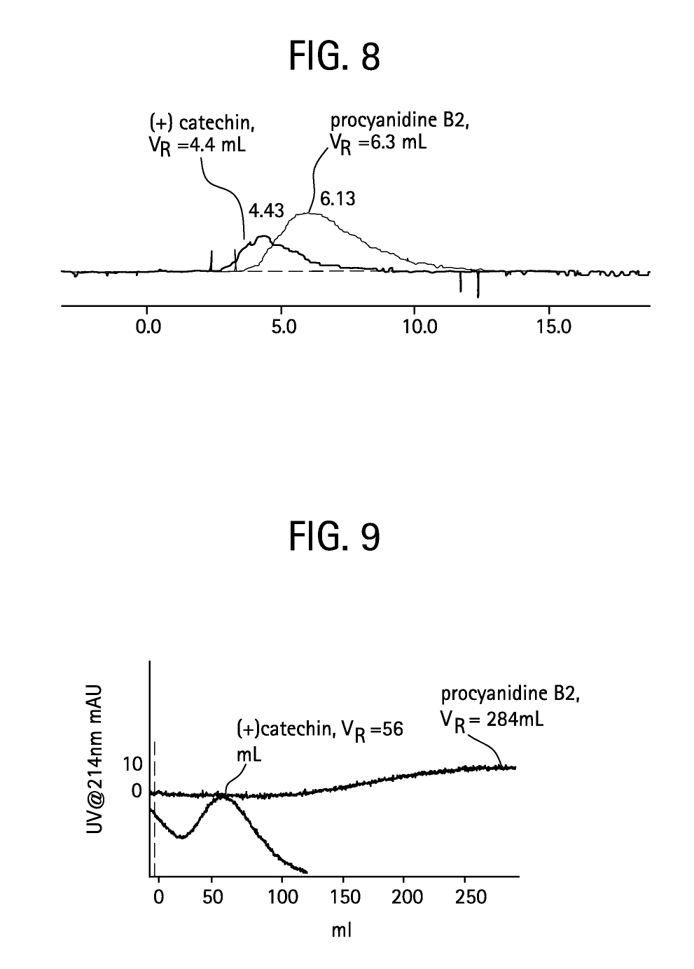

Haze forming substances can vary greatly not only between different process fluids but even, in the case of beer, from lot to lot of the same beer type. Hence it is important to not only offer haze reduction data but also data based on scavenging of polyphenol standards. Retardation and adsorption of standard polyphenols was measured by ultra-violet adsorption at 214 nm and based on two standards—the monomeric flavanol (+) catechin and the dimeric flavanol procyanidin B2. Although beer and other bioprocess streams may contain multimeric polyphenols it is felt that they are not as numerous as dimeric polyphenols and that the multimeric polyphenols often form haze complexes in the initial stages of the process where they may be largely removed in clarification steps. It was of interest to measure the retardation of an aliquot of these polyphenols standards as they were pumped through the porous particle and filter beds of the different prototypes. Results are summarized in table 3 and in FIGS. 8 to 11.

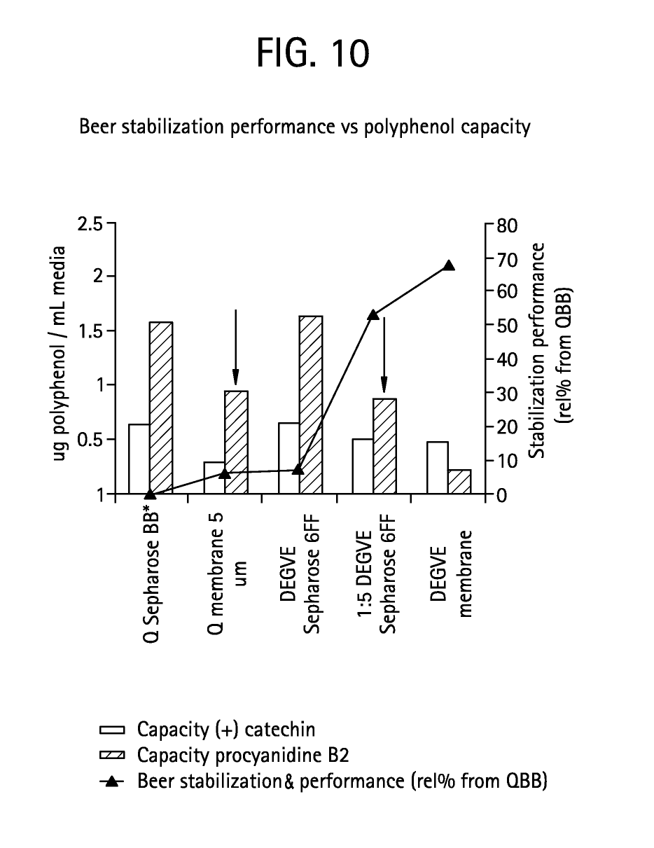

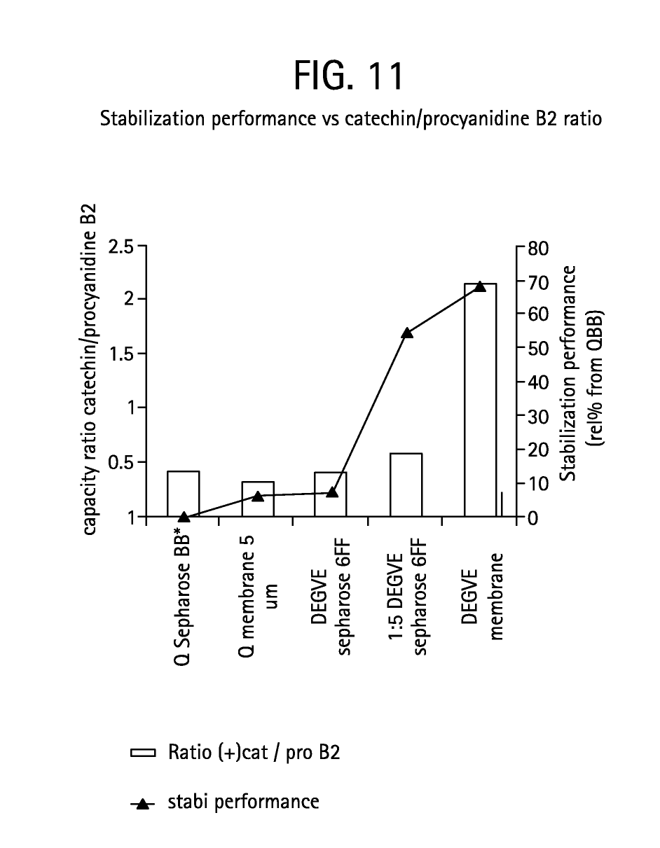

Elution volumes of polyphenols (+)-catechin and procyanidine B2 were noted to compare relative elution as sign of the strength of interaction between the standards and the surface tested. In addition the actual adsorbed amounts of polyphenols were calculated by integrating eluted peak area and bypass area of the polyphenols. The adsorbed amount/capacity is calculated by subtracting the integrated bypass column peak area with peak area of eluted polyphenol that has been processed through the particle column or filter bed (table 3). It was seen that the elution volumes of the polyphenols did not correlate directly to beer stabilization performance. Q SEPHAROSE™ BB and Q membrane U20760049 performed equal in beer stabilization but polyphenols retard differently on the Q membrane (FIGS. 8 and 9). Looking at the amount of polyphenol adsorbed it was seen that prototypes which stabilize beer as good as Q SEPHAROSE™ BB preferentially adsorb dimeric standard procyanidine B2 to a relatively greater extent than the monomeric standard (+) catechin. The ratio of adsorbed (+)catechin to procyanidine B2 yielded a clear correlation with haze reduction performance. As the dimeric polyphenol is favored for scavenging the ratio decreases and the surfaces in question behave more like Q Big Beads, independent of the surface treatment being charged (i.e. Q) or uncharged (DEGVE) modification (FIGS. 10 and 11).

This selective behavior, that good haze forming substance preferentially scavenge more active haze forming substances such as dimeric polyphenols, and that such behavior can be obtained by uncharged (e.g. DEGVE coated) surfaces is in line with development of ideal filters or other porous media which can both clarify and stabilize polyphenol containing process streams.

One exciting aspect of FIG. 11 is that it suggests surfaces which do not scavenge monomeric flavanols will leave them in solution where they can further inhibit haze formation. Monomeric flavanols have only one strong binding site to adsorb to the haze active polypeptide and is therefore less able to crosslink polypeptides. If large excess of monomeric flavanols are present in beer in comparison to dimeric or higher oligomeric to proanthocyanidines the monomeric species may occupy the binding sites and inhibit the oligomers to bind and crosslink polypeptides. Comparison between Q membrane and the prototype where 1 part DEGVE SEPHAROSE™ 6FF was mixed with 4 parts SEPHAROSE™ 6FF it was seen that both prototypes adsorb equal amount procyanidine B2 but the DEGVE SEPHAROSE™/SEPHAROSE™ 6FF prototype adsorbed more (+)catechin such that haze stability was not as effective.

FIG. 11 suggests that in addition to dimer removal one way to stabilize some process streams may be to add monomeric flavanols to the stream in manner to reduce the monomer to dimer levels. Such addition may be allowed for some types of fluid processing but not for others. Possible monomeric flavanol analogues may also work including various amino acids and vitamins which offer monomeric phenol groups.

It should be noted that given that some secondary interactions may occur between bound dimeric polyphenols and monomeric polyphenols it is probably not possible to design a filter or other device which does not remove some monomeric polyphenols. However it has been shown here that significant alteration in their ratios can be effected. It is tempting to speculate a ratio below which stabilization will be attained but clearly a single ratio cannot be given, at this time, for the broad and varied range of fluid samples which may benefit from the invention. That may be possible in the future with online or offline polyphenol analysis used to control stabilization processes.

The ideal scavenging stabilization treatment may be a solid phase based method involving simple, stable, biocompatible and low fouling surface treatments or materials, and which favor scavenging of polyphenol substances which strongly promote haze formation. Such approaches would, if desired, allow for all of process stream to be processed and so allow coupling of clarification and stabilization steps. The clarification and stabilization properties of any related product would both be of great importance. to Filters which have various charged or other ligands attached to them so that they can scavenge contaminants or capture target substances from bioprocess and other fluid streams are well known.

Examples include the positively charged SARTOBIND® Q (Sartorius AG, Goettingen, Germany) and MUSTANG® Q filters (Pall Corp, Ann Arbor, Mich., USA) which are often used to scavenge nucleic acid contaminants from recombinant protein bioprocess streams. In such scavenging filters MW exclusion ranges may not be designed to affect a second, equally important size exclusion function as much as to optimize adsorptive surface area.

Of course it is possible that filters or other porous beds intended to remove haze particles (not haze forming chemical entities) might be modified with various groups which can enhance haze particle trapping. These could include surface modification with PVPP or silica groups or various charged entities. EP 0 392 395 describes Use of a Microporous Membrane Composed of a Polymer Substrate and a Surface Coating of the Substrate by Polyacrylic Acid or Methacrylic Acid Derivative for the Filtration of Beer. The membrane is “suitable in particular for the microbial stabilization of beer and for removal of haze particles”. Such polyacids may be rather non-specific scavengers and tend to reduce the size of various flow channels. Thus as noted in the patent they may be more ideally suited to micron sized particles. As in the case of silica gels it is expected that the negative charged surfaces may react more with proteins than polyphenols.

### EXAMPLES

The present examples are presented herein for illustrative purpose only, and should not be constructed to limit the invention as defined by the appended claims.

### Evaluation Strategy

Unfiltered and non-stabilized beer was chosen as representative process fluid prone to the dual challenges of a need for both clarification and stabilization against chill haze formation.

Experiments were done with control commercial reference media and several different prototypes which included both chromatography particles and filters. Filters capable of filtering one size of particle are generally applicable to similar challenges. The general ability of the stabilization results to be related to wider range of process streams, and if need be reproduced in other laboratories, was ensured by not only stabilizing beer but also measuring the ability of the various filters and chromatographic particles to remove pure chemical reagents analogous in structure to monomeric and dimeric polyphenols found in various process streams.

All prototypes and reference media were either commercially available or based on particles or filters which are available from GE Healthcare or GE Water. Reference media was Q modified SEPHAROSE™ cross-linked agarose Big Beads (GE Healthcare) used in the commercial Combined Stabilization System (CSS) apparatus sold via Handtman. As such stabilization results from this media can be taken as suitable for a commercial product. SEPHAROSE™ 6 Fast Flow (FF) particles (GE Healthcare) were also used. Regenerated cellulose (cellulose acetate or CA) membranes (GE Water) as well as CA membranes modified for purposes of these experiments with either Q ligands, or in situ polymerized diethylene glycol vinyl ether (DEGVE) surface treatment via radical initiated grafting. In addition DEGVE polymer coated CA membranes were prepared by first producing DEGVE polymers and then grafting the polymers to the epoxy activated membrane surfaces.

Two different non-stabilized and non-sterile filtrated but Kiselguhrfiltrated beer to samples were used in the present studies. The samples were obtained approximately five months apart to increase their randomness. They were typically tested at different times, due in part to the relative time necessary to affect each experiment. Control experiments using Q SEPHAROSE™ Big Beads matched those obtained over a three year period with other beer standards and polyphenol standards.

TABLE 1
Description of Protype Tested Media.

| Prototype | Description |
|---|---|
| U20760049 Q Modified | 5 μm pore size cellulose acetate (CA) based membrane |
| Commercial 5 μm CA Membrane | from GE Water. Membrane thickness is 100 μm. Cross- |
| | linked with epichlorohydrin (ECH). Quarternary |
| | ammonium (Q) ligand coupled. Ligand density 0.090 mmol/mL |
| | membrane from method using 10 mM KNO3. |
| Commercial 1.2 μm CA membrane | 1.2 μm pore size CA membrane from GE Water. |
| lot A077200C | |
| U220080 ECH cross-linked CA base | 5 μm pore size ECH cross-linked cellulose acetate |
| membrane | membrane from GE Water. |
| U2277039 DEGVE membrane | Di(ethylene) glycol vinyl ether grafted 5 μm pore ECH |
| | cross-linked CA membrane from GE Water. |
| U2277038 DEGVE SEPHAROSE ™ | Di(ethylene) glycol vinyl ether grafted SEPHAROSE ™ |
| 6 FF | FF via allylation. |
| Mixture 1 volume DEGVE | 1part U2277038 and 4 part SEPHAROSE ™ 6FF base |
| SEPHAROSE ™ 6FF U2277039 and | matrix lot T-276064. |
| 4 volumes SEPHAROSE ™ 6FF | |

The experimental strategy for Particle Removal was to use a Sysmex combined imaging particle analyzer (Sysmex Corp., Japan) for particle analysis to measure the number and distribution of micron sized particles in the process stream before and after passage of various amounts of unfiltered beer up to 800 mL through a 1 mL filter or 1-3 mL volume bed (see below), particle removal. Typical results are summarized in FIG. 2. As all the test filters and particles used in the study offered reasonable particle clearance they were all used in follow on studies related to both Chill Haze Reduction and Scavenging of Polyphenol Standards related to polypenols with different haze forming capabilities. Chill Haze Analysis was related to EBC haze units measured by Tannometer (Pfeuffer GMBH, Kitzingen, Germany) as in a brewery or fruit juice plant. By lowering the temperature and adding alcohol into the beer, the solubility of the reversible protein-polyphenol complexes was decreased and precipitation appeared. Since the Chill haze induces permanent haze the value from the Chill haze analysis was an important factor for predicting colloidal stability (FIGS. 3 to 6). Retardation and adsorption of standard polyphenols was based on two flavanols (+) catechin and procyanidine B2. The (+)-catechin is a monomeric flavanol and procyanidine B2 is a dimeric proanthocyanidine. Although beer and other bioprocess streams may contain multimeric polyphenols it is felt that they are noit as numerous as dimeric polyphenols and that the multimeric polyphenols often form haze complexes in the initial stages of the process where they may be largely removed in clarification steps. It was of interest to inject and retard an aliquot of these polyphenols standards onto the prototypes too se if any correlation with beer stability was present (FIGS. 7 to 9).

### Experimental Details

1 Synthesis of DEGVE SEPHAROSE™ 6FF and DEGVE membrane

### 1.1 DEGVE SEPHAROSE™ 6FF

### Allylation (U2277037)

Approximately 100 mL SEPHAROSE™ 6FF (GE Healthcare) was washed with water on a sintered glass filter. 50 g humid particles and 100 g 50% NaOH (w/w) was added to a 500 mL round-bottom flask equipped with a mechanical stirrer. The stiffing was started, and the vessel was immersed in a water bath set at 50° C. The suspension was stirred for 30 minutes.

to 200 g Allyl glycidyl ether was added, and the stirring rate was increased to obtain a homogeneous suspension. The reaction was left for 18 h at 50° C. The suspension was transferred to a sintered glass filter, and the particles were washed with 500 mL of distilled water and 500 mL of ethanol.

### Radical-Initiated Grafting of Di(Ethylene Glycol) Vinyl Ether (U2277038)

10 g of humid allylated SEPHAROSE™ 6FF prepared as described above, was put in a 100 mL round-bottom flask equipped with a mechanical stirrer. A solution of 1.6 g 2,2′-azobis(2-methylbutyronitrile) (AMBN, available from Fluka) dissolved in 40 g di(ethylene glycol) vinyl ether (available from Sigma Aldrich) was prepared. When the initiator was completely dissolved the solution was transferred to the round-bottom flask. The reaction was allowed to proceed in an inert environment at 70° C. for 18 h. The particles were washed on a sintered glass filter with 500 mL of distilled water and 500 mL of ethanol.

### Estimation of Ligand Density U2277038

Ligand density was measured with dry content determination using a Halogen moisture analyzer (Mettler Toledo). Few milliliters of allylated SEPHAROSE™ 6FF (U2277037) and DEGVE SEPHAROSE™ (U2277038) were poured into 2 PD 10 columns, id 1.66 cm (GE Healthcare). The resins were washed with 2 cv MILLI-Q® water. The gel heights for settled beads were noted and the resins were transferred with MILLI-Q® water into tared metal dishes. The resins were dried in the halogen moisture analyzer at 105° C. until they were completely dry. The weights were noted. The ligand density (mmol/mL) was calculated by subtracting the dry weight of U2277037 with dry weight of U2277038 and to divide with molecular mass of DEGVE (132.16 g/mol). The ligand density was calculated to 0.759 mmol/mL resin.

### 1.2 DEGVE Membrane

### Epoxy Activation (U2277039)

260 g Distilled water and 26 mL 50% NaOH were mixed in a 250 mL spinner flask. 40 mL epichlorohydrin was added to the solution. After ˜10 minutes the cross-linked GE Water CA membrane (dry) was placed in a roll of plastic net, and added into the spinner flask. The reaction was allowed to proceed at 30° C. for 2 h. The membrane roll was washed 6 times (stirring for 2 min each time) with distilled water.

### Polymerization of Di(Ethylene Glycol) Vinyl Ether (U2277040)

6.3 g AMBN and 163 mL di(ethylene glycol) vinyl ether were mixed in a 250 mL round-bottom flask. The reaction was allowed to proceed in an inert environment at 70° C. for 19 h.

### Grafting of the Polymerized Di(Ethylene Glycol) Vinyl Ether (U2277041)

163 g Distilled water and the polymerized di(ethylene glycol) vinyl ether, from above, were mixed in a 250 mL spinner flask. The epoxy activated membrane (wet) from above, which was placed in a roll of plastic net, was added into the spinner flask. The reaction was allowed to proceed at 30° C. for 1 h. 10.5 mL 50% NaOH was added and the reaction was allowed to proceed at 30° C. for 21 h. The membrane was washed 6 times (stirring for 2 min each time) with distilled water.

### 2. Application and Analysis

Haze intensity is defined is defined by a EBC scale (Analytica-EBC, Method 9.29, 5th Edn., 1997) which involves the measurement of light scattering at an angle of 90 degrees, typically via use of a tannometer. The EBC scale is linear. There are other units scales with good correlation to the EBC scale including the Nephelometric Turbidity Unit (NTU) scale and the American Society of Brewing Chemists (ASBC) scale.

### 2.1 Materials

### 2.1.1 Column Packing

XK 16 column, GE Healthcare
Membrane holder, active id=26 mm, GE Healthcare
Packing pump, P-900, GE Healthcare

### 2.1.2 Beer Application

Cornelius bottles for beer

### Pump P-900, GE Healthcare

Measure flasks 50-500 mL

### Incubator, 0° C., id 5174, MIR153, Sanyo

### 2.1.3 Chapon Chill Haze

### Tannometer, id 18200126, Pfeuffer GMBH, Kitzingen, Germany

### Quartz Cuvette 4 cm, Pfeuffer GMBH, Kitzingen, Germany

### 2.1.4 Polyphenol Adsorption Study

ÄKTAexplorer 10 system with autosampler, GE Healthcare

### 3. Chemicals

### 3.1 Column Packing

MILLI-Q® water (Millipore Corp., Billercia, USA)

### 3.2 Beer Application

Unfiltered non-stabilized lager beer, Uppsala lager beer, Slottkällans Brewery AB
MILLI-Q® water

### 3.3 Chapon's Chill Haze

### Ethanol, 99.5%

### Ethyleneglycol, 40%

MILLI-Q® water

### 3.4 Polyphenol Adsorption Study

(+) catechin art no C1251-5G lot 142788320909016 (Sigma)

### Procyanidine B2 art no 42157 lot 142788320909016 (Sigma)

### KCl, pa

Phosphoric acid, pa

### Solutions

### A-buffer: 0.1M KCl+Phosphoric Acid pH ˜4

15.0 g KCl was weighed into a 2000 mL beaker. 1900 mL MILLI-Q® water was added to the beaker and the solution was mixed with a stirrer. A single drop of phosphoric acid was put into the beaker to get a pH of ˜4.

k+)Catechin 0.4 mg/mL

40 mg (+)catechin hydrate was weighed into a 100 mL glass beaker. The substance was dissolved in few mL A-buffer. The solution was transferred into a 100 mL volumetric flask and diluted to the mark with A buffer. The solution was mixed well. The sample solution was transferred into 2 ml eppendorff tubes and stored in a 4-8° C. refrigerator before use.

Procyandin B2 1 mg/mL

1 mL of A-buffer was pipetted into a vial containing 1 mg procyanidine B2. The vial was mixed by hand shaking and 100 μL portions of this sample were transferred into 200 μL conical vials aimed the auto-sampler of the ÄKTAexplorer 10 system.

### 4. Methods

### 4.1 Packing of Beads in Column

App ˜5 mL of resin was washed on a G3 glass filter with 5 cv MILLI-Q® water. The resin was transferred into a plastic beaker and MILLI-Q® water was added until a 50% gel-mixture was obtained. The XK16 column was packed at 15 mL/min and the gel height was adjusted to 0.50 cm to obtain a gel volume of 1.0 to 3.0 mL, depending on prototype.

### to 4.2 Packing of Membrane Prototypes

16 pieces with id 32 mm of membrane were punched and put into the membrane holder. Two o-rings were applied to avoid leakage on the edge of the membrane and to confirm that liquid passes through the membrane. The active diameter was 26 mm and 16 pieces of 100 μm thick membrane gives a total membrane volume of 1 mL.

### 4.3 Beer Application

The Cornelius bottle, containing 18 L filtrated non-stabilized beer, was attached by a tube to the P-900 pump. The beer was cooled to 0° C. in an incubator for >2 days. The bead columns and membrane holder were connected to the beer and 1000 mL beer was pumped through the column at 13 mL/min The processed beer was collected into measure flasks according to table 1. The samples were sampled into a 10 mL polypropylene sample tube. The tubes were overfilled and the cap was attached immediately after filling. The samples were stored at 0° C. before analysis. The samples were analyzed within 12 hours. The non-stabilized lager beer from Slottkällans brewery was only stable for four days and all prototype testing and sampling must be made during this period.

TABLE 2
Fraction collection of stabilized beer samples

| Fraction no | Beer volume |
|---|---|
| 1 | 0-100 mL |
| 2 | 100-300 mL |
| 3 | 700-800 mL |

### 4.4 Chill Haze Analysis

0.6 mL 40% ethylene glycol was added into the cuvette-chamber of the Tannometer before analysis to increase the thermal contact between the sample and the cooler. The beer sample was added into a 100 mL flask and agitated strongly until all carbon dioxide was eliminated. 4 mL of the beer sample was pipetted into a cuvette and also 0.12 or 0.24 to mL ethanol was added depending on beer. First beer 0.24 mL ethanol was added and second lot beer 0.12 mL was added. The “Chill Haze” analysis was started. Chill haze is the precipitation that occurs when cooling the beer to −8° C. The higher level of “Chill haze” the shorter shelf life of beer regarding to colloidal stability. In this case the chill haze analysis was compared with Q SEPHAROSE™ BB as reference and the prototypes. It is important to process the same beer on Q SEPHAROSE™ BB and the prototypes within 24 hours since the beer stability is low and its chemical composition changes rapidly during storage.

### 4.5 Polyphenol Analyses

Polyphenol retardation and adsorption was performed on the prototypes to see if any correlation between chill haze stability and polyphenol adsorption was present. Table 3 show the figures for the polyphenol adsorption study. Elution volumes of polyphenols (+)-catechin and procyanidine B2 are noted and also adsorbed amount polyphenol is calculated by integrating eluted peak area and bypass area of the polyphenols. The adsorbed amount/capacity is calculated by subtracting the integrated bypass column peak area with peak area of eluted polyphenol that has been processed through column. It was seen that the elution volumes of the polyphenols did not correlate to beer stabilization performance. Q SEPHAROSE™ BB and Q membrane U20760049 performed equal in beer stabilization but the polyphenols retard earlier for the Q membrane. Looking at the amount polyphenol adsorbed it was seen that prototypes that stabilize beer as good as Q SEPHAROSE™ BB preferentially adsorb the dimeric standard procyanidine B2 to a relatively larger extent than the monomeric standard (+) catechin. By dividing the to amount adsorbed (+)catechin with adsorbed amount procyanidine B2 yielded a clear correlation with haze reduction performance (FIG. 9).

TABLE 3
Polyphenol adsorption and retardation data on different prototypes

| | | | | | | | Adorbed | | |
|---|---|---|---|---|---|---|---|---|---|
| | | | | | adsorbed | adsorbed | amount | | |
| | | | | | amount | amount | catechin/ | | Haze |
| | Elution + | Elution | | | (+)-catechin | procyanidin | Adsorbed | | performance |
| | catechin | procyanidin | (+)-catechin | procyanidin | (ug/mL | B2 (ug/mL | amount | Ligandhalt | (rel % |
| prototype | (mL) | B2 (mL) | (yield %) | B2 (yield %) | media) | media) | prodelphinidine | (mmol/mL) | from QBB) |
| Q Sepharose BB* | 56 | 214 | 35.9 | 37.3 | 0.641 | 1.5675 | 0.41 | 0.217 | 0 |
| Q membrane 5 um | 4.4 | 6.3 | 70 | 62 | 0.3 | 0.95 | 0.32 | 0.09 | 6.6 |
| CA membrane 1.2 | — | — | — | — | — | — | — | — | 97.6 |
| um | | | | | | | | | |
| DEGVE Sepharose | 36 | 75 | 34 | 34 | 0.66 | 1.65 | 0.40 | 0.759 | 7.4 |
| 6FF | | | | | | | | | |
| 1:5 DEGVE | 6.6 | 8.2 | 49 | 65 | 0.51 | 0.875 | 0.58 | 0.1518 | 53.4 |
| Sepharose 6FF | | | | | | | | | |
| DEGVE membrane | 5.4 | 5.7 | 52 | 91 | 0.48 | 0.225 | 2.13 | N/A | 67.4 |

It is apparent that many modifications and variations of the invention as hereinabove set forth may be made without departing from the spirit and scope thereof. The specific embodiments described are given by way of example only, and the invention is limited only by the terms of the appended claims.

What is claimed is:

1. A method for liquid processing comprising contacting a liquid with a separation matrix which allows for both colloidal particle removal by size exclusion, and stabilization against haze formation by adsorptive removal of haze forming substances, to be accomplished in the same operation, wherein the separation matrix comprises a polymeric porous support in the form of a filter, membrane or monolith.

2. The method of claim 1, wherein the pore size of the porous support is at least 1.2 μm.

3. The method of claim 2, wherein said support is modified with cationic ligands, preferably quaternary ammonium groups, on its surface(s) for adsorptive removal of haze forming substances.

4. The method of claim 3, wherein the support is able to process 100-2000 ml liquid per ml support with a contact time of less than 1 minute.

5. The method of claim 1, wherein the surfaces of said polymeric support exhibit hydroxyl groups.

6. The method of claim 1, wherein the polymeric support includes polycarbonyl, polyhydroxy, polyether, polysulfone, or polyacid groups.

7. The method of claim 1, wherein the support is surface-modified with hydrogen bond donator or acceptor groups.

8. The method of claim 7, wherein the hydrogen bonding groups comprise lone-pair electrons and are based on polymers or other ligands containing, for example, hydroxyl groups, ether groups, carboxyl groups, carbonyl groups, amine groups.

9. The method of claim 7, wherein the hydrogen bonding groups are ethylene glycol or other ethoxy based ligands.

10. The method of claim 9, wherein the ether-ligands are in mixture with other ligands or media.

11. The method of claim 7, wherein the hydrogen bonding groups comprise ethylene glycol or Tris or similar functionalities (e.g. proline or inositol groups).

12. The method of claim 7, wherein the hydrogen bonding groups comprise part of a responsive polymer or silicone based polymer.

13. The method of claim 1, wherein the separation matrix comprises a filter, cross flow filter, packed chromatography bed, expanded chromatography bed, radial flow chromatography bed, and involves various solid phase separation media (particles, porous beads, monoliths, fabric, membranes etc.).

14. The method of claim 13, wherein the separation matrix has hydrogen bonding and filtration capacity which are achieved using the same material, e.g. regenerated cellulose, or cross-linked agarose or other polysaccharide.

15. The method of claim 1, wherein the adsorptive surface has specificity for a subclass of haze forming substances such as certain types of proteins or certain types of polyphenol tannins, including dimeric polyphenols such as dimeric flavanols.

16. The method of claim 1, wherein the adsorptive surface is improved via modification with various surface treatments including exposure to oxidative, reducing or other reagents, covalent grafting of quaternary ammonium or other cationic ligands, covalent grafting or irreversible adsorption of various polymers which provide hydrogen bonding or other groups, modification of surface by various treatments involving chemical reactions at the surface including radical initiated grafting of vinyl ether reagents or plasma radio frequency based treatments.

17. The method of claim 1, wherein said liquid is a beverage selected from beer, wine, juice or flavorings.

18. The method of claim 1, wherein said liquid is a plant extract including fluid related to bioprocessing of recombinant plant products.

19. The method of claim 1, wherein the relative ratio of monomeric polyphenols is increased in relation to the dimeric or higher polyphenols in the liquid to be processed.
